(19) United States
(12) Patent Application Publication
(10) Pub. No.: US 2017/0249301 A1
(43) Pub. Date: Aug. 31, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Toru OTSUKA, Kanagawa (JP)

(73) Assignee: FUJI XEROX CO., LTD., Tokyo (JP)

(21) Appl. No.: 15/211,562

(22) Filed: Jul. 15, 2016

(30) Foreign Application Priority Data
Feb. 25, 2016 (JP) 2016-034460

(51) Int. Cl. G06F 17/28; G06K 9/34; G06K 9/00

(52) U.S. Cl. CPC G06F 17/2854; G06K 9/00442; G06K 9/344; G06K 2209/01

(57) ABSTRACT

A non-transitory computer readable medium stores a program causing a computer to execute a process for displaying text. The process includes displaying in association with each other a text region extracted from image information and including an image of a text, an original text that is obtained by performing character recognition on the image of the text included in the text region, and a translation text into which the original text is translated.

### CROSS-REFERENCE TO RELATED APPLICATIONS

This application is based on and claims priority under 35 USC 119 from Japanese Patent Application No. 2016-034460 filed Feb. 25, 2016.

### BACKGROUND

### Technical Field

The present invention relates to an information processing apparatus, an information processing method, and a non-transitory computer readable medium.

### SUMMARY

According to an aspect of the invention there is provided a non-transitory computer readable medium. The non-transitory computer readable medium stores a program causing a computer to execute a process for displaying text. The process includes displaying a text region extracted from image information and including an image of a text, an original text that is obtained by performing character recognition on the image of the text included in the text region, and a translation text into which the original text is translated.

### BRIEF DESCRIPTION OF THE DRAWINGS

Exemplary embodiment of the present invention will be described in detail based on the following figures, wherein:

FIG. 1 is a block diagram illustrating the configuration of an information processing apparatus of an exemplary embodiment;

FIG. 2 diagrammatically illustrates an example of a screen that is displayed when a request to translate a document is received;

FIG. 3 diagrammatically illustrates an example of the configuration of image information that is received by a document receiving unit;

FIG. 4 diagrammatically illustrates an example of text regions extracted by a text region extracting unit;

FIG. 5 is a table illustrating the configuration of original and translation comparison information;

FIG. 6 diagrammatically illustrates the configuration of a screen displayed by a display control unit;

FIG. 7 is a flowchart illustrating an operation example of the information processing apparatus: and

FIG. 8 diagrammatically illustrates another example of the configuration of the screen displayed by the display control unit.

### DETAILED DESCRIPTION

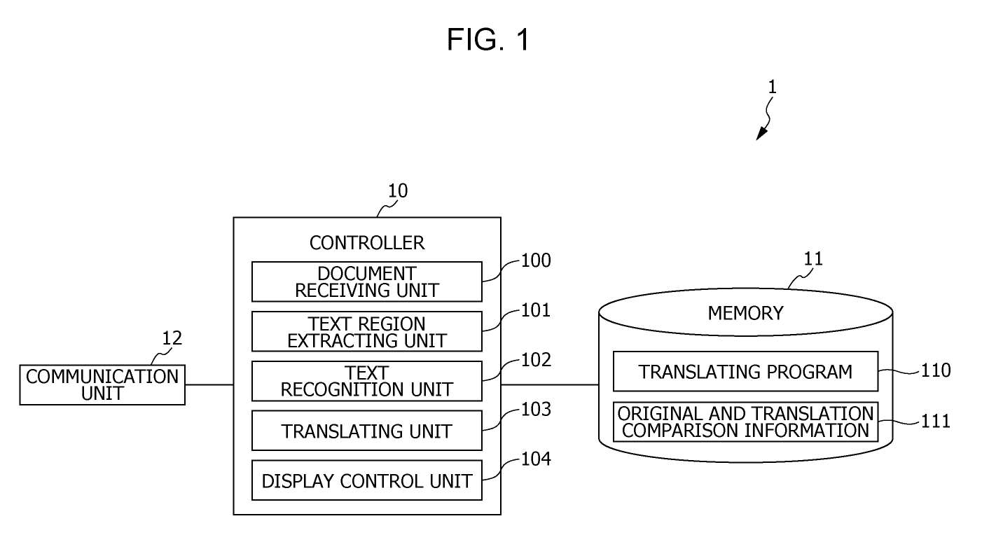

FIG. 1 is a block diagram illustrating the configuration of an information processing apparatus 1 of an exemplary embodiment.

The information processing apparatus 1 includes a central processing unit (CPU), and controls elements therewithin. The information processing apparatus 1 includes a controller 10 that executes a variety of programs, a memory 11 that includes a storage medium, such as a flash memory, and stores information, and a communication unit 12 that communicates with the outside via a network.

By executing a translating program 110 to be discussed below, the controller 10 implements a document receiving unit 100, a text region extracting unit 101, a text recognition unit 102, a translating unit 103, a display control unit 104, and the like.

The document receiving unit 100 receives document information from the outside via the communication unit 12. The document information includes image information that is obtained by scanning printed matter of characters or images, or image information including characters or images.

The text region extracting unit 101 extracts as a text region an area where a text is arranged if the image information received by the document receiving unit 100 includes the text. The text region extracting unit 101 registers the coordinates, the height and the width of the extracted text region in original and translation comparison information 111.

The text recognition unit 102 recognizes the text included in the test region extracted by the text region extracting unit 101 using optical character recognition (OCR) technique or the like, thereby generating text information. The text recognition unit 102 registers as an original text the generated text information in original and translation comparison information 111.

The translating unit 103 translates the text information generated as the original text by the text recognition unit 102 into another language, thereby generating a translation text. The translating unit 103 registers the generated translation text in the original and translation comparison information 111.

The display control unit 104 displays the received image information, the original text, and the translation in association with each other by displaying an operation screen or by referencing the original and translation comparison information 111.

The memory 11 stores the original and translation comparison information 111 and the translating program 110 that causes the controller 10 to function as the document receiving unit 100 through the display control unit 104.

The information processing apparatus 1 is connected to a terminal (not illustrated) via the communication unit 12 and a network, and transmits operation results in response to a request from the terminal. Upon receiving the operation results, the terminal displays the screen described below on the display thereof.

The operation of the exemplary embodiment is described below.

A user may access the information processing apparatus 1 using the terminal (not illustrated), and requests a document to be translated.

In response to the request from the terminal, the information processing apparatus 1 causes the display of the terminal to display the screen described below.

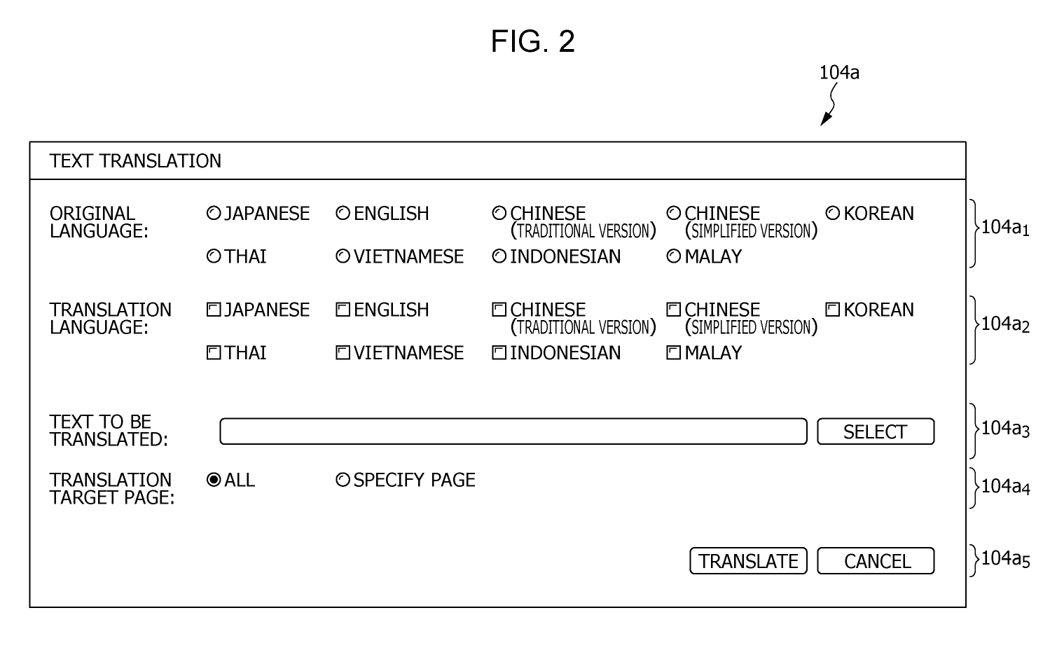

FIG. 2 diagrammatically illustrates an example of a screen 104a that is displayed when a request to translate a document is received.

The screen 104a includes a selection section 104a₁ to select the language of an original text, a selection section 104a₂ to select the language of a translation text, a selection section 104a₃ to select a document that is to be translated, a selection text 104a₄ to select a page of the document serving as a translation target, and a button 104a₅ to execute or cancel translation.

The user selects the language of the original text using the selection section 104a₁, selects the language of the translation text using the selection section 104a₂, specifies document information serving a translation target using the selection section 104a₃, and selects a page using the selection section 104a₄. The user then presses the button 104a₅ to execute the translation.

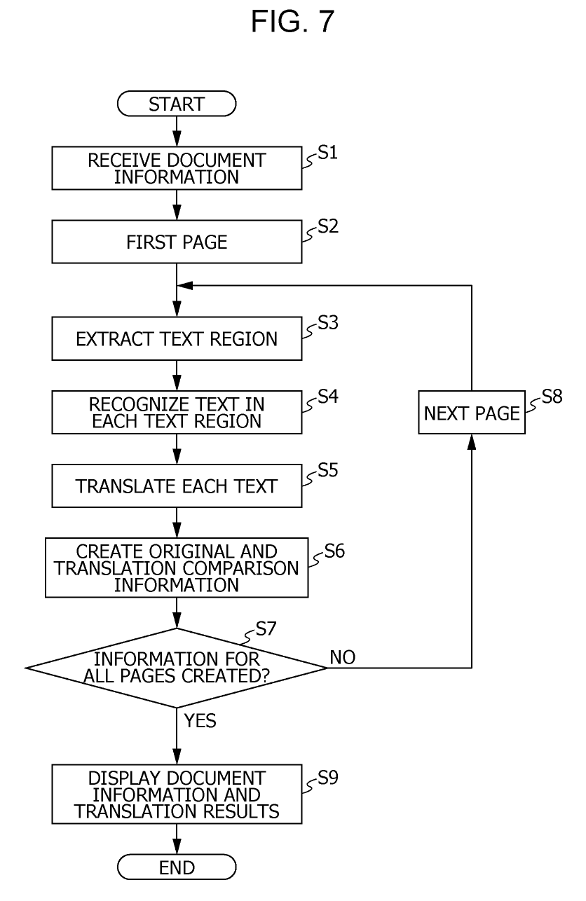

FIG. 7 is a flowchart illustrating the operation example of the information processing apparatus 1.

The document receiving unit 100 receives the document information specified by the selection section 104a₃ (S1). The document information may be image information as described below, for example.

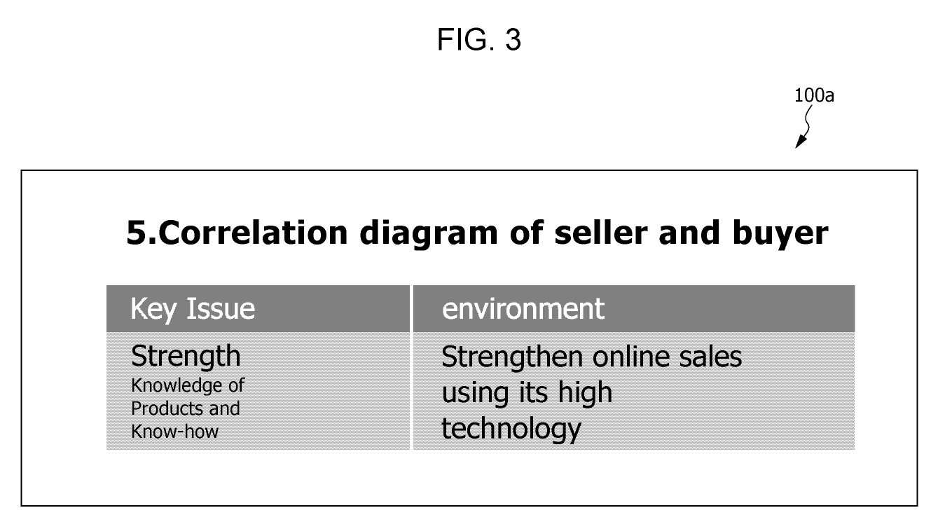

FIG. 3 diagrammatically illustrates an example of the configuration of image information 100a received by the document receiving unit 100.

The image information 100a includes a table including a title section reading “5. Correlation of diagram of seller and buyer”, and listing sections “Key Issue” and “environment”.

The text region extracting unit 101 extracts as a text region an area where a text is arranged, from a first page (S2) of the image information 100a received by the document receiving unit 100 (S3). A technique, such as layout structure recognition, is used to extract the text region.

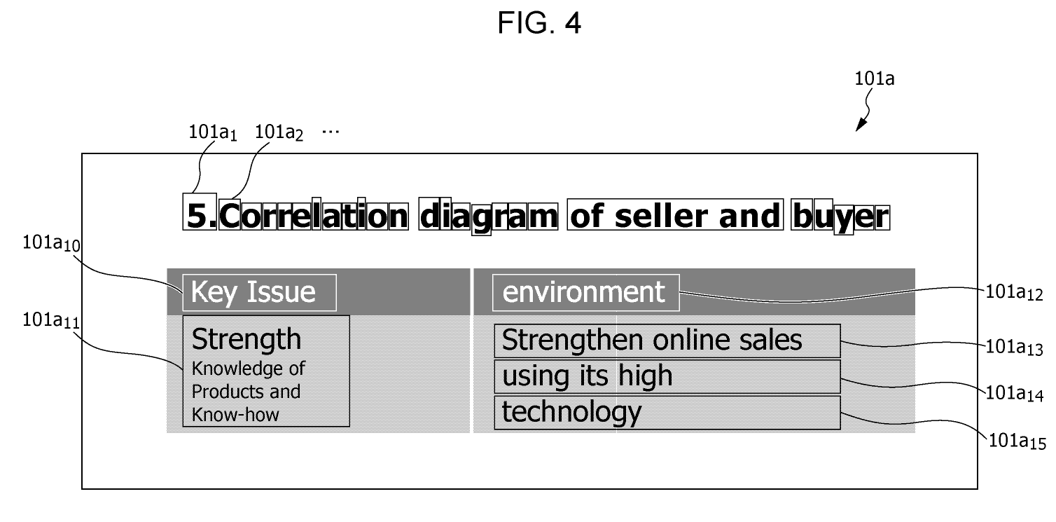

FIG. 4 diagrammatically illustrates an example of text regions extracted by the text region extracting unit 101.

Text regions 101a₁, 101a₂, . . . , 101a₁₀, . . . , 101a₁₅ are extracted from the image information 100a by the text region extracting unit 101. Text regions are typically extracted by word or by phrase, as text regions 101a₁₀, . . . , 101a₁₅. The text regions may also be extracted by character, as text regions 101a₁, 101a₂, . . . .

The text recognition unit 102 recognizes texts included in the text regions extracted by the text region extracting unit 101 using a technique, such as OCR technique (S4), and generates the text information.

The translating unit 103 translates, as an original text, text information, including a character, a word, a phrase, and a sentence, generated by the text recognition unit 102 into another language, thereby generating a translation text (S5).

The text region extracting unit 101 registers the coordinates, the height, and the width of the text region extracted by the text region extracting unit 101 in the original and translation comparison information 111. The text recognition unit 102 registers the generated text information in the original and translation comparison information 111. The translating unit 103 registers the generated translation text in the original and translation comparison information 111 (S6).

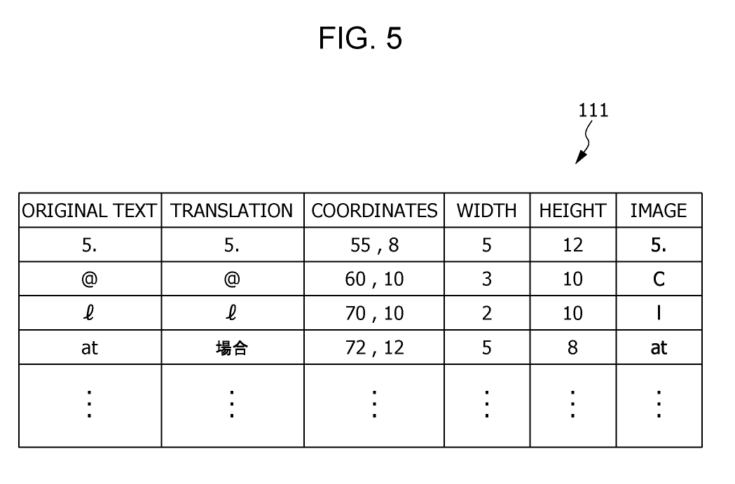

FIG. 5 is a table illustrating the configuration of original and translation comparison information 111.

The original and translation comparison information 111 includes the original text that results from performing character recognition on an image in the text region, the translation text into which the original text is translated, the coordinates, the height, and the width of the text region, and the image of the text included in the text region. Referring to FIG. 5, if the image of the text includes a shaded character, character “C” may be erratically recognized as character “@”. When the user simply checks the translation text against the original text, it may be difficult to determine which character in the image the recognition results have been obtained from.

Operations in steps S3 through S6 are repeated on each of the pages of the document information (S7 and S8).

The display control unit 104 references the original and translation comparison information 111, and displays the received image information, the original text, and the translation text in association with each other (S9).

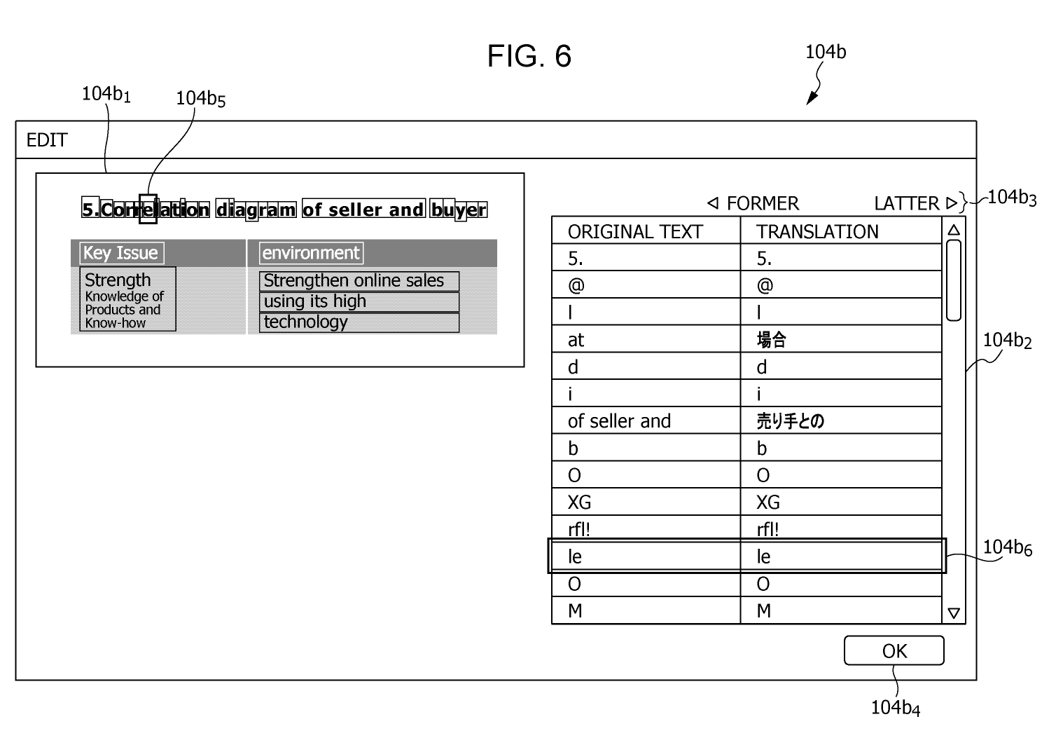

FIG. 6 diagrammatically illustrates the configuration of a screen 104b displayed by the display control unit 104.

The screen 104b includes a document display section 104b₁ that displays the received image information and the extracted text region, a translation result display section 104b₂ that displays the original text and the translation text, a page turning button 104b₃ that turns pages if the document information includes multiple pages, an OK button 104b₄ that ends the displaying of the screen 104b, a selection frame 104b₅ that selects the text region of the image information, and a selection frame 104b₆ that selects the pair of the original text and the translation text.

If one of the selection frame 104b₅ and the selection frame 104b₆ is selected, the other of the selection frame 104b₅ and the selection frame 104b₆ is automatically selected. More specifically, if a text region is selected in the image using the selection frame 104b₅, the user may learn what character the text included in the text region is recognized to be, and how the recognition results are translated. If the original text and the translation text are selected using the selection frame 104b₆, the user may learn which text region in the image the original text and the translation text are in.

A common code may be assigned to the text region, and the pair of the original text and translation text responsive to the text region to indicate an association relationship therebetween. The association relationship may also be indicated by using frames of the same color or by using an arrow mark.

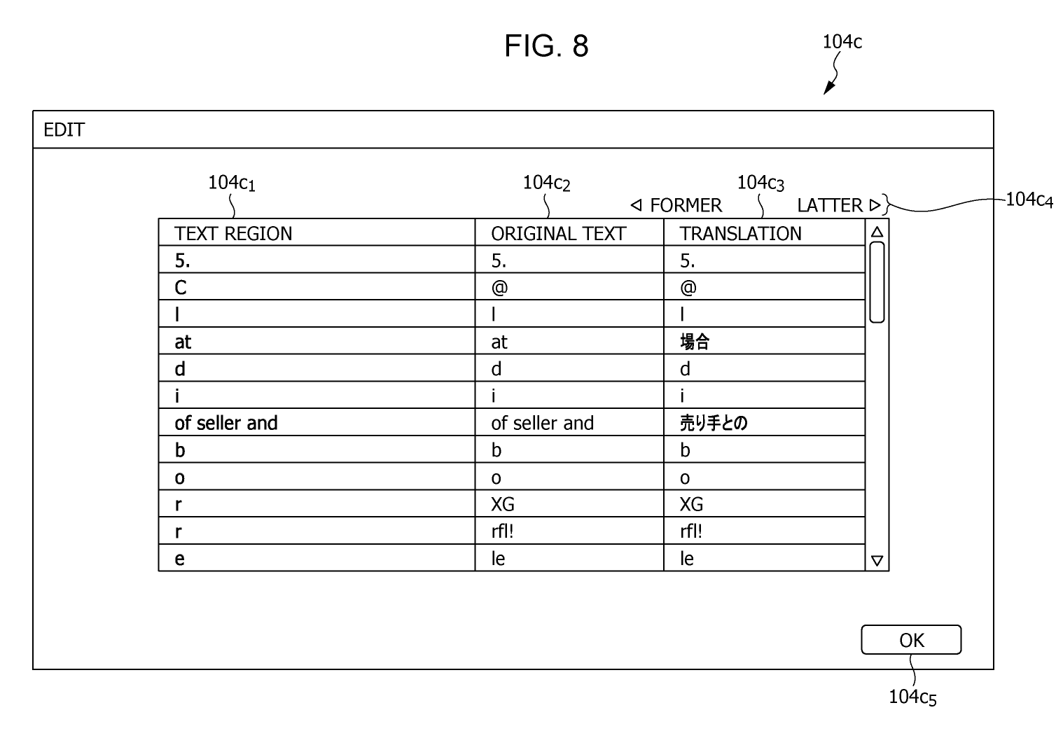

The present invention is not limited to the exemplary embodiment described above. A variety of modifications is possible without departing from the scope of the invention. For example, the document display region 104b₁ illustrated in FIG. 6 may be omitted. As illustrated in FIG. 8, images included in the text regions may be respectively displayed for the pairs of original texts and translation texts.

FIG. 8 diagrammatically illustrates another example of the configuration of the screen displayed by the display control unit 104.

A screen 104c includes a text region 104c₁ that displays an image included in a text region, an original text 104c₂ that indicates a text recognized from the text region, a translation text 104c₃ that indicates a translation sentence into which an original sentence is translated, a page turning button 104c₄ that turns pages if the document information includes multiple pages, and an OK button 104c₅ that ends the displaying of the screen 104c.

In the exemplary embodiment, the functions of the document receiving unit 100 through the display control unit 104 in the controller 10 are implemented using a computer program. Part or whole of the document receiving unit 100 through the display control unit 104 may be implemented using hardware, such as application specific integrated circuit (ASIC). The computer program used in the exemplary embodiment may be supplied in the form of a recording medium, such as a compact disk read-only memory (CD-ROM). Some of the steps of the exemplary embodiment may be interchanged, some of the steps may be deleted, or a step may be added as long as the scope of the present invention remains unchanged.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A non-transitory computer readable medium storing a program causing a computer to execute a process for displaying text, the process comprising first displaying sections including a text region extracted from image information and including an image of a text, receiving designation of one of the sections and second displaying (1) the image of the text of the designated section, (2) the text that is obtained by performing character recognition on the image of the text of the designated section, and (3) a translation text into which the text of the designated section is translated, the image of the text, the text that is obtained by performing character recognition and the translation text being displayed in a same screen.

2. (canceled)

3. An information processing apparatus comprising a display control unit that first displays sections each including a text region extracted from image information and including an image of a text, the display control unit configured to receive a designation of one of the sections and second display (1) the image of the text in the designated section, (2) the text that is obtained by performing character recognition on the image of the text of the designated section, and (3) a translation text into which the text of the designated section is translated, the image of the text, the text that is obtained by performing character recognition and the translation text being displayed in a same screen.

4. (canceled)
